(19) United States
(12) Patent Application Publication
(10) Pub. No.: US 2014/0180931 A1
(43) Pub. Date: Jun. 26, 2014

(54) System and Method for Secure Wi-Fi- Based Payments Using Mobile Communication Devices

(71) Applicants: David Lie, Toronto (CA); Lian Ting Ni, Toronto (CA)

(72) Inventors: David Lie, Toronto (CA); Lian Ting Ni, Toronto (CA)

(21) Appl. No.: 14/101,330

(22) Filed: Dec. 9, 2013

Related U.S. Application Data
(60) Provisional application No. 61/734,943, filed on Dec. 7, 2012.

(51) Int. Cl. G06Q 20/40

(52) U.S. Cl. CPC G06Q 20/401
USPC 705/75

(57) ABSTRACT

A secure mobile payment method provides a customer with full functionality of a mobile communication device while operating in conjunction with security protocols for internet communication, such as TLS/SSL, and uses a digital signature to provide message integrity and sender verification. The method further employs a public-private key, where the sender hashes a message with a cryptographic hash and signs the hash with a private key, and a recipient uses the sender's public key to decrypt the hash value.

### CROSS REFERENCE TO RELATED APPLICATION

The present application is related to Provisional patent application entitled “A Secure Wi-Fi Based Mobile Payment System Scheme,” filed 7 Dec. 2012 and assigned filing No. 61/734,943, incorporated herein by reference in its entirety.

### FIELD OF THE INVENTION

The present invention relates to a system and method for conducting mobile online transactions and, in particular, to a method of securely browsing for and purchasing commodities and services using a mobile communication device.

### BACKGROUND OF THE INVENTION

The mobile market has grown exponentially in recent years, from 739 million mobile subscriptions worldwide in 2000 to an estimated 5.3 billion in 2010. The market growth is matched at every step by the development of mobile technology. Every quarter, new mobile communication devices, capable of doing more at a faster speed, are made available to the consumer.

What started merely as a less reliable but portable version of the home phone is now not only just as dependable, but it also supports a variety of communication methods (besides voice calling) such as text messaging, picture messaging, and even video calling. In addition, the mobile communication device can also be used as a personal planner, a timepiece, a notebook, an alarm, a text reader, and/or an entertainment device.

With the increasing versatility and prevalence of such devices, more and more users are placing their trust in the mobile communication devices to keep their personal data secure and on hand. In recent years, users are even trusting their smart phones in regard to their finances, and are using their mobile communication devices to make monetary payments and conduct other financial transactions.

As can be appreciated by one skilled in the art, most mobile communication devices produced today are also Wi-Fi capable. In the present state of the art, there are various protocols and devices developed for the Internet which are well tested, continuously updated, and adaptable to provide almost any type of secure communication system, but are typically not present in a consumer mobile communication device. What is needed is a method of secure mobile payment that provides a user with full functionality of a mobile communication device while also operating in conjunction with security protocols for Internet communication.

### BRIEF SUMMARY OF THE INVENTION

In one aspect of the present invention, a method for conducting secure online transactions comprises: establishing a secure communication network connection with at least one of a vendor and a vendor website; verifying authenticity of a financial entity from which the vendor or the vendor website accepts payment; initiating a financial transaction with the vendor or the vendor website using the secure communication network connection; and completing the financial transaction using a payment method supported by the financial entity.

In another aspect of the present invention, a system for enabling secure online transactions comprises a customer mobile communication device having access to the Internet; a vendor terminal having access to the Internet such that a secure communication network connection is established between the vendor terminal and the customer mobile communication device; and a credit card workstation having access to the Internet such that a secure direct communication channel is provided between the credit card workstation and the vendor terminal.

The additional features and advantage of the disclosed invention is set forth in the detailed description which follows, and will be apparent to those skilled in the art from the description or recognized by practicing the invention as described, together with the claims and appended drawings.

### BRIEF DESCRIPTIONS OF THE DRAWINGS

The foregoing aspects, uses, and advantages of the present invention will be more fully appreciated as the same becomes better understood from the following detailed description of the present invention when viewed in conjunction with the accompanying figures, in which:

FIG. 1 is a diagrammatical illustration of a mobile device secure payment system, in accordance with an aspect of the present invention;

FIG. 2 is a functional diagram illustrating the process of authentication and establishment of a communication network connection, in the system of FIG. 1;

FIG. 3 is a flow diagram illustrating operation of the mobile device secure payment system of FIG. 1;

FIG. 4 is a functional diagram illustrating the process of executing a customer transaction, using the mobile device secure payment system of FIG. 1;

FIG. 5 is a diagrammatical illustration of a vendor name provided in the display of a user mobile communication device, in accordance with an aspect of the present invention;

FIG. 6 is a diagrammatical illustration of a mobile device display showing a transaction total and vendor information that a payment or credit card company may use to identify a vendor and transfer money, and

FIG. 7 is a diagrammatical illustration of a mobile device display showing a convenience store transaction total amount and a corresponding checkout counter number.

### DETAILED DESCRIPTION OF THE INVENTION

The following detailed description is of the best currently contemplated modes of carrying out the invention. The description, which is not to be taken in a limiting sense and is made merely for the purpose of illustrating the general principles of the invention, provides: (i) a description of the protocols that the innovative payment method utilizes, (ii) the prerequisites preferred for implementing the innovative payment method, and (iii) a description of the innovative payment method.

The innovative payment method functions in accordance with Transport Layer Security/Secure Socket Layer (TLS/SSL), a cryptographic transport layer protocol that provides secure end-to-end communication. In accordance with the disclosed secure payment method, TLS/SSL may be used to create a secure communication channel between a customer and a payment or credit card company entity, and between the customer and a vendor or a vendor website. Protocol for TLS/SSL transmission has been defined in Request for Comments (RFC) 5246 for “Transportation Layer Security Protocol” published by the Network Working Group. The establishment of a secure end-to-end channel prevents others in the network from discovering sensitive information or tempering with communications made among the customer (i.e., customer/user), the payment or credit card company (i.e., financial entity), and the vendor (i.e., vendor/service provider).

The disclosed method utilizes a Digital Signature, where the digital signature provides message integrity and sender verification so that the recipient knows the communication or message has not been tampered with and is authentic. In an exemplary embodiment, a sender signs a message using a selected secret code known only to the sender, and sends the signed message to a recipient who is able to verify the authentication of the message (i.e. that the signed message really is from the sender). In addition, the integrity of the information in the message may be verified (i.e. that the message was not modified in transit) without requiring access to the signer's secret code.

The disclosed secure Wi-Fi based payment method employs a public-private key, where: (i) the sender hashes the message with a cryptographic hash; (ii) the sender signs the hash with a private key; and. (iii) the receiver uses the sender's public key to decrypt the hash value. The hash attests to the integrity of the message, and the digital signature serves to authenticate the identity of the sender.

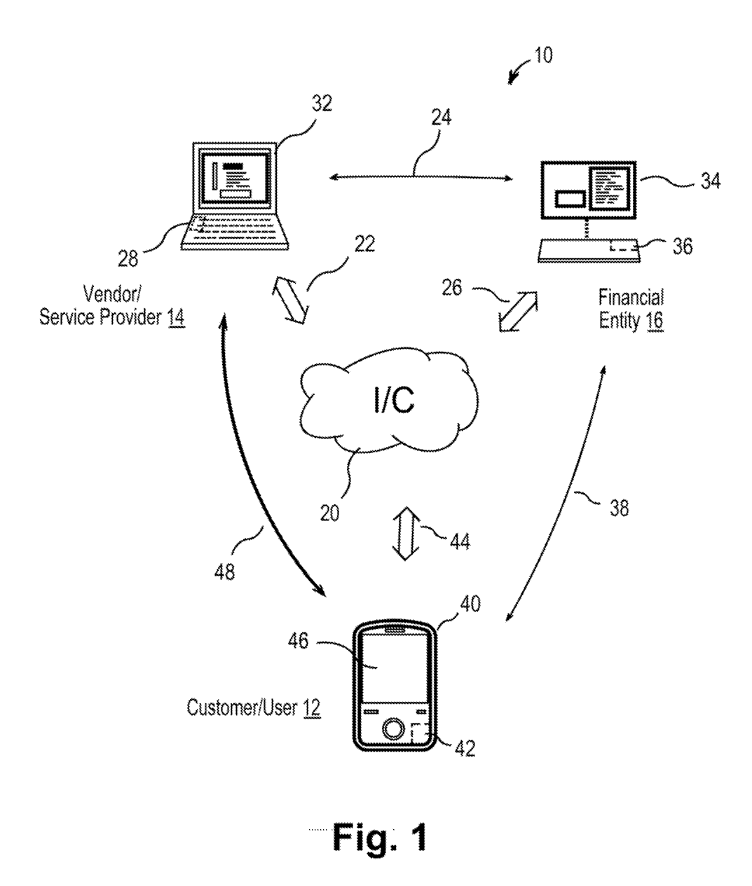

As illustrated in a mobile device secure payment system 10 shown in FIG. 1, the disclosed secure payment method is reliant upon the participation and cooperation of the three parties involved in the transaction, that is, the customer/user 12, the vendor/service provider 14, and the financial entity 16 (i.e., the payment or credit card company). Accordingly, one or more of the following basic requirements may be met in an exemplary embodiment:

Basic Requirement A. The vendor/service provider 14 may have a vendor website with a vendor Internet connection 22 or may have a direct connection 24 with one or more financial entities 16 from which the vendor/service provider 14 is willing to accept payment. The direct connection 24 may or may not be a secure connection. The vendor Internet connection 22 has a bandwidth sufficiently large to support such transactions on the vendor website. The vendor/service provider 14 will have an established Wi-Fi network capable of supporting anticipated customer activity.

The preferred Internet bandwidth capacity may depend on vendor size and the number of expected customer transactions. Anticipated customer activity may be a function of: (i) the services the vendor/service provider 14 may wish to provide via the website or other communication means, (ii) the number of customers or website visitors the vendor/service provider 14 expects to serve, and (iii) the desired coverage area, a parameter which will vary among different vendors.

The financial entity 16 may also operate via a financial entity Internet connection 26 so as to communicate with the vendor/service provider 14 via the Internet/cloud 20 and the vendor Internet connection 22. In the diagram, the vendor/service provider 14 is exemplified by a vendor terminal 32 supporting the vendor website, and the financial entity 16 exemplified by a credit card workstation 34.

Basic Requirement B. The vendor/service provider 14 will have a valid digital certificate 28 for identification, where the valid vendor digital certificate 28 may be registered with one or more financial entities 16 from which the vendor/service provider 14 is willing to accept payment. Similarly, the financial entity 16 may have a valid digital certificate 36.

Basic Requirement C. As part of the registration process, the vendor/service provider 14 and the financial entity 16 will exchange each other's public key(s). This may be accomplished using a secure communication channel between the vendor terminal 32 and the credit card workstation 34.

Basic Requirement D. The customer/user 12 will have entered or stored credit information needed in the transaction on a customer mobile communication device 40, prior to subsequent on-line transactions. The customer/user 12 may accomplish this by entering credit information when setting up a payment software application 42 in the customer mobile communication device 40. The payment software application 32 encrypts and stores the customer credit information, and the payment software application 32 may also include a private key for the customer/user 12.

The customer mobile communication device 40 may access the Internet/cloud 20 via a Wi-Fi link 44 and communicate with the vendor/service provider 14 via the vendor Internet connection 22 in an optionally secured mode. The customer mobile communication device 40 may also communicate with the financial entity 16 via the financial entity Internet connection 26, also in an optionally secured mode. Required information and prompts may be provided in a display 46 on the customer mobile communication device 40.

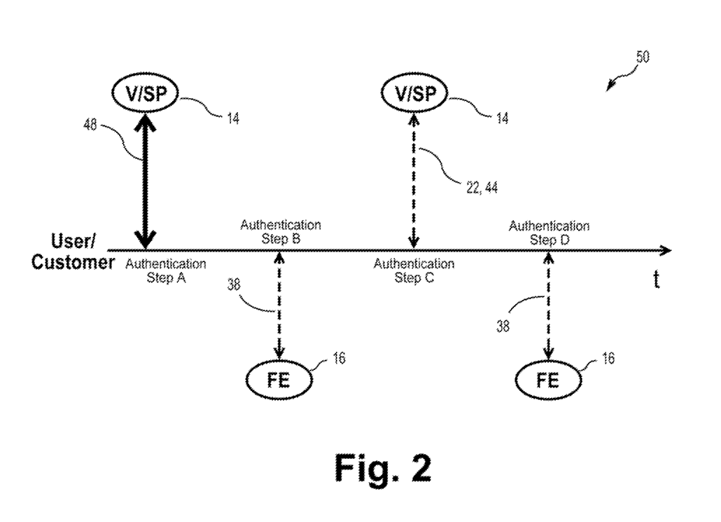

Referring also to FIGS. 2-4, the disclosed secure Wi-Fi based mobile device payment method may comprise three phases: (i) an authentication phase that includes authentication and establishment of a secure communication network connection 48, shown in FIG. 1; (ii) a browsing phase that includes browsing by the customer/user 12, where the optional browsing session may be customizable, and (iii) a transaction phase that includes the actual transaction(s) executed by the customer/user 12, the vendor/service provider 14, and/or the financial entity 16. Actions that may be taken in the authentication phase 50 are illustrated in FIG. 2.

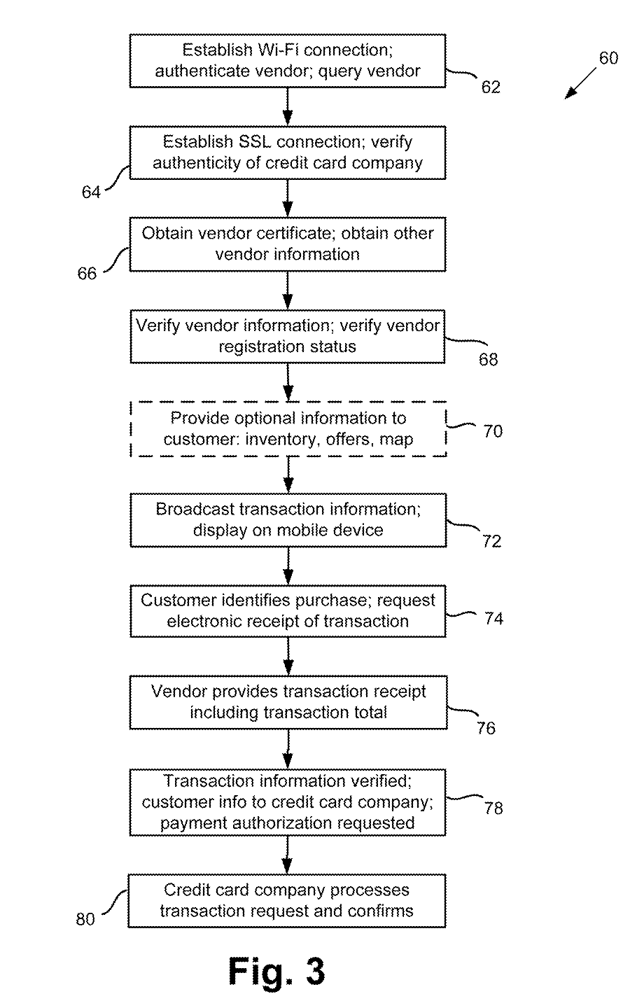

The authentication phase 50 may occur anytime between the time the customer/user 12 enters the Wi-Fi coverage of the vendor/service provider 14, and the time when the customer/user 12 queues up at a checkout or payment facility (not shown). A step-by-step description of the disclosed secure payment method is provided in steps 62 through 80 in a flow diagram 60, shown in FIG. 3, where the initial steps correspond to the authentication phase 50.

The customer mobile communication device 40 may establish a Wi-Fi Connection, at step 62. The customer/user 12 can make a preliminary identity authentication of the vendor/service provider 14, and may query the vendor/service provider 14 for supported payment options. Preferably, the vendor authentication step establishes that the customer mobile communication device 40 is attempting to connect to a desired vendor. In an exemplary embodiment, the customer/user 12 may use the customer mobile communication device 40 to obtain the name of the vendor/service provider 14.

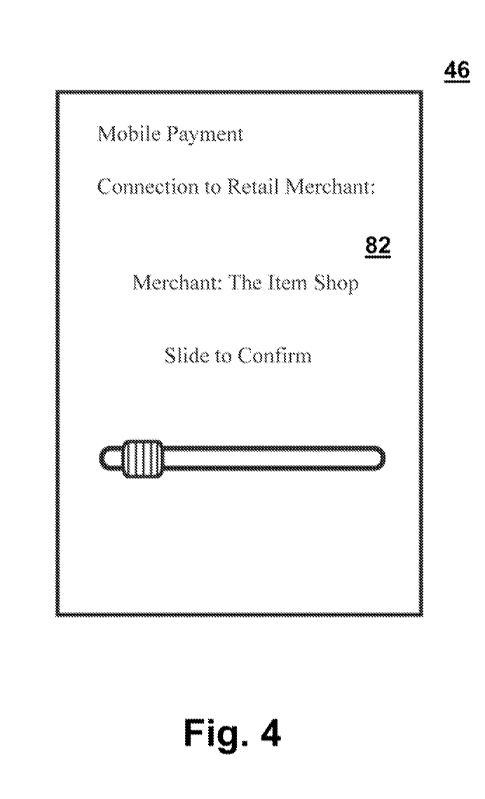

This identification may be accomplished by displaying the vendor name in the display 46 of the customer mobile communication device 40. For example, the display 46 in FIG. 4 is displaying the name of a convenience store 82. This display serves to verify to the customer/user 12 that the vendor being contacted is the vendor/service provider 14 that the user intends to connect with. These actions are diagrammatically represented at Authentication Step A in the authentication phase 50 diagram of FIG. 2, and require the secure communication network connection 48.

Using the information on supported payments provided by the vendor/service provider 14 from step 62, along with credit information entered by the customer/user 12, the customer/user 12 may access the customer mobile communication device 40 to establish a Secure Socket Layer (SSL) connection with the desired financial entity 16, at step 64. The authenticity of the credit card workstation 34 may be validated by use of a digital certificate, as known in the relevant art. The query may be sent and received via the optionally secure link 38, as indicated at Authentication Step B in FIG. 2.

It can be appreciated that step 64 in FIG. 3 may not be required for every transaction. For example, in the case where the customer/user 12 has been patronizing more than one commercial establishment in the same online session, and needs to connect to the financial entity 16 more than once, the customer mobile communication device 40 needs only to resume a previously-established SSL session, since establishing a new connections for every successive transaction would be a waste of resources.

At step 66, the customer mobile communication device 40 may establish the authenticity of the vendor/service provider 14, via an optionally secure link 38, by obtaining a vendor certificate as signed by the financial entity 16. The financial entity 16 may obtain the vendor certificate via an SSL connection with the vendor/service provider 14, such as by using the direct connection 24. The customer mobile communication device 40 can optionally receive other vendor information as needed, at step 66 (i.e., at Authentication Step C via links 22, 44, in FIG. 2).

At step 68, the customer mobile communication device 40 may verify the information obtained from the vendor/service provider 14, such as information pertaining to payment, with the financial entity 16. For example, the customer mobile communication device 40 could obtain a vendor I.D., in step 66, and verify with the financial entity 16 that the registration of the vendor/service provider 14 has not been revoked. This action corresponds to Authentication Step D, which may be made via the optionally secure line 38.

Step 70 in the flow diagram 60 corresponds to the browsing phase of the disclosed secure Wi-Fi based payment method. Step 70 is optional, and may vary from vendor to vendor depending on what the particular vendor may wish to support, as well as what services may be provided by the vendor which the customer/user 12 wants to utilize. For example, the vendor/service provider 14 could allow the customer/user 12 to obtain one or more of: inventory information, promotional offers, recommendations, or directions within the store upon request. Services could even be extended to provide an easy way to locate store personnel or to ask questions. Encryption is optional and would depend on the nature of the information being transferred and user preferences. For example, a map of the store would be provided to all customers and would not need to be encrypted, whereas individual queries for items may be encrypted to protect the privacy of the customer/user 12.

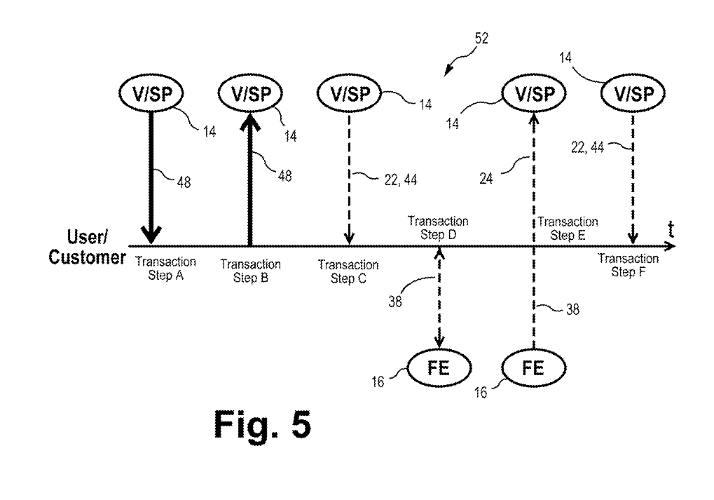

At step 72, the vendor/service provider 14 may broadcast information for each transaction for use in uniquely identifying a transaction (with an attached reference number for each transaction), as the transactions are processed to all mobile communication devices that may be “listening” for a vendor broadcast. The vendor information may be transmitted to the customer mobile communication device 40 via the secure communication network connection 48, as indicated by Transaction Step A in the transaction phase 52 diagram of FIG. 5.

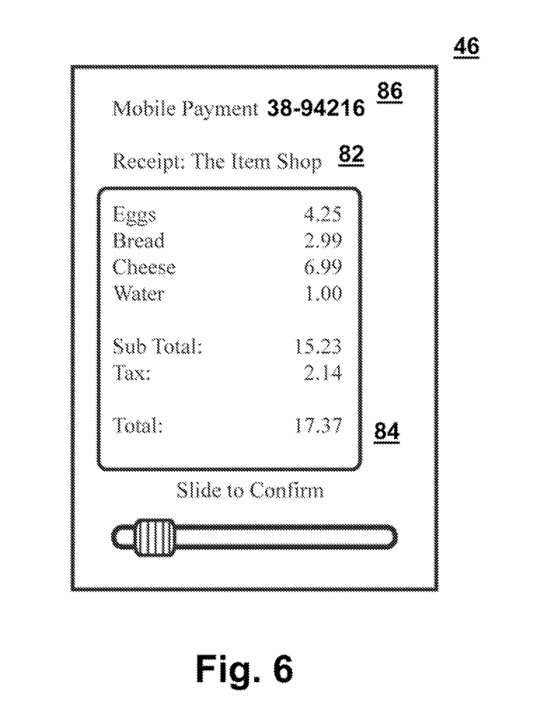

The customer mobile communication device 40 may then display the identification information so the customer/user 12 can use the identification information to identify a purchase. Preferably, the identifying information comprises the amount of information needed to identify a transaction, and could differ from vendor to vendor. For example, as shown in FIG. 6, the convenience store 82 may send a transaction total amount 84 and the corresponding reference number, such as a checkout counter number 86, to the display 46.

At step 74, the customer/user 12 may identify and select a purchase after the transaction total amount 84 has been displayed, and execute the desired financial transaction while still using the secure communication network connection 48. The mobile communication device 40 may send a request for a full electronic receipt of the transaction using the reference number associated with the customer's purchase, as indicated by Transaction Step B in the transaction phase 52 diagram of FIG. 5.

At step 76, the vendor/service provider 14 may respond to the request of the customer/user 12 by providing a transaction receipt for customer verification as well as a digitally-signed message for the customer/user 12 to forward to the financial entity 16. The message for the financial entity 16 may contain: (i) the transaction total 84 and (II) vendor information that the financial entity 16 would need to identify the vendor/service provider 14 and to transfer money (e.g., vendor account information). The response from the vendor/service provider 14 may be made via a secure link, such as the secure communication network connection 48, or may be unsecured using links 22, 44, as indicated by Transaction Step C in the transaction phase 52 diagram of FIG. 5.

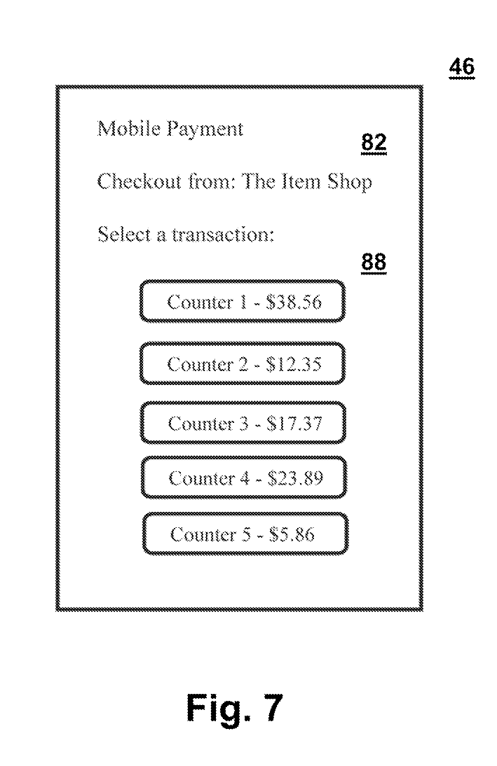

The information in the transaction receipt may be displayed to the customer/user 12 for verification on the display 46, as shown in FIG. 7. If the customer/user 12 finds that the transaction receipt information for a particular transaction 88, for example, does not match the purchase, steps 74 and 76 may be repeated until the correct transaction has been retrieved, or until an upper limit of transaction retrieval re-tries has been reached.

Step 78 provides that, after the customer/user 12 has verified the transaction information, the customer mobile communication device 40 may send the customer's credit information (such as payment or credit card number), transaction information, payment authorization, and the vendor's message to the corresponding financial entity 16, via the optionally secure link 38. The transaction information may also contain the transaction total amount 84.

At step 80 the financial entity 16 may process the transaction request, and may respond with confirmation of payment or reason for denial, to the customer mobile communication device 40. If payment is unsuccessful, the customer/user 12 may re-attempt to make a payment depending on the corresponding problem via the optionally secure link 38, as indicated in Transaction Step D in the transaction phase 52 diagram of FIG. 5.

The confirmation of payment may be signed by the financial entity 16, and forwarded to the vendor 24. The confirmation of payment may include: the time of transaction, the transaction total 84, and pre-defined information identifying both the vendor/service provider 14 and the customer/user 12, as indicated in Transaction Step E in the transaction phase 52 diagram of FIG. 5. A similar notification may be provided to the customer/user 12 by the vendor/service provider 14, as indicated in Transaction Step F in the transaction phase 52 diagram of FIG. 5.

It is to be understood that the description herein is only exemplary of the invention, and is intended to provide an overview for the understanding of the nature and character of the disclosed system and method for secure online transactions. The accompanying drawings are included to provide a further understanding of various features and embodiments of the method and devices of the invention which, together with their description serve to explain the principles and operation of the invention.

What is claimed is:

1. A method suitable for making secure Wi-Fi-based payments using a customer mobile communication device, said method comprising the steps of:
establishing a secure communication network connection with at least one of a vendor and a vendor website;
verifying authenticity of a financial entity from which said vendor or said vendor website accepts payment;
initiating a financial transaction with said vendor or said vendor website using said secure communication network connection; and
completing said financial transaction using a payment method supported by said financial entity.

2. The method of claim 1 wherein at least one of said vendor website and said financial entity has a valid digital certificate.

3. The method of claim 1 wherein said vendor website has a digital certificate registered with said financial entity.

4. The method of claim 1 wherein said step of establishing comprises the step of obtaining a digital certificate from said vendor website.

5. The method of claim 1 wherein said step of completing said financial transaction comprises the step of obtaining payment authorization from said financial entity.

6. The method of claim 1 wherein said step of completing said financial transaction comprises the step of obtaining a transaction receipt.

7. The method of claim 1 further comprising the step of providing a direct Internet connection between said vendor website and said financial entity.

8. The method of claim 1 further comprising the step of exchanging public encryption keys between said vendor and said financial entity as part of a registration process.

9. The method of claim 1 further comprising the step of storing customer credit information on a customer mobile communication device prior to said step of establishing a secure communication network connection with at least one of a vendor and a vendor website.

10. The method of claim 9 wherein said step of storing credit information on a customer mobile communication device comprises the step of providing a private encryption key for use in said customer mobile communication device.

11. The method of claim 10 further comprising the step of encrypting and storing said customer credit information in said customer mobile communication device.

12. The method of claim 9 wherein said step of establishing a secure communication network connection with said vendor website comprises the step of providing a private key for use with said customer mobile communication device.

13. The method of claim 1 further comprising the step of using Transport Layer Security/Secure Socket Layer to create a secure communication channel between said vendor website and said financial entity.

14. The method of claim 1 further comprising the step of using Transport Layer Security/Secure Socket Layer to create a secure communication channel between said vendor website and the customer mobile communication device.

15. The method of claim 1 further comprising the step of using Transport Layer Security/Secure Socket Layer to create a secure communication channel between said financial entity and the customer mobile communication device.

16. A mobile device secure payment system comprising:
a customer mobile communication device having access to the Internet;
a vendor terminal having access to the Internet such that a secure communication network connection is established between said vendor terminal and said customer mobile communication device; and
a credit card workstation having access to the Internet such that a secure direct communication channel is provided between said credit card workstation and said vendor terminal.

17. The system of claim 16 wherein said vendor terminal comprises a valid digital certificate registered with said credit card workstation.

18. The system of claim 16 wherein said credit card workstation comprises a valid digital certificate.

19. The system of claim 16 wherein said customer mobile communication device comprises a private encryption key.

20. The system of claim 16 further comprising a secure communication channel created using Transport Layer Security/Secure Socket Layer, said secure communication channel providing a communication link between at least two of said financial entity, said vendor terminal, and the customer mobile communication device.
